(19) United States
(12) Patent Application Publication
(10) Pub. No.: US 2026/0218567 A1
(43) Pub. Date: Jul. 30, 2026

(54) ELECTRIC WINDOW COVERING, ELECTRIC WINDOW COVERING SYSTEM, AND WINDOW COVERING ALIGNMENT METHOD

(71) Applicant: Nien Made Enterprise Co., Ltd., Taichung City (TW)

(72) Inventors: You-Yu Zhang, Taichung City (TW); SHIH-WEI HSU, Taichung City (TW)

(73) Assignee: Nien Made Enterprise Co., Ltd., Taichung City (TW)

(21) Appl. No.: 19/227,940

(22) Filed: Jun. 4, 2025

(30) Foreign Application Priority Data
Jan. 24, 2025 (TW) 114103322

(51) Int. Cl. E06B 9/322

(52) U.S. Cl. CPC E06B 9/322

(57) ABSTRACT

An electric window covering system and alignment method are disclosed. The system includes a first electric window covering comprising an upper rail, a lower rail, a lower rail driving assembly, a control device, and a power supply unit. The lower rail moves relative to the upper rail between upper and lower limit positions. Upon receiving a specific remote control command, the control device transmits a first alignment packet to a second electric window covering and receives a second alignment packet. The control device then aligns the lower rail based on the first and second alignment packets, which include information about the current positions of the lower rails of the first and second electric window coverings when stopped or stationary.

### FIELD OF INVENTION

The present disclosure relates to an electric window covering, an electric window covering system, and a window covering alignment method. More specifically, the disclosure relates to an electric window covering, electric window covering system, and window covering alignment method that facilitate the automatic alignment of multiple lower rails among a plurality of electric window coverings.

### BACKGROUND OF THE PRESENT INVENTION

With advancements in technology, contemporary electric window coverings have evolved to the extent that a single wireless control command, issued via a wireless remote-control device, can simultaneously execute identical actions across multiple electric window coverings on the same facade or within the same group of a building. This eliminates the need for users to individually control each electric window covering when users want to achieve the same shading height across multiple windows of identical height. However, since communication between the wireless remote-control device and the electric window coverings relies on wireless signals, factors such as distance or physical obstructions (e.g., furniture) can cause variations in the timing at which each electric window covering receives the wireless control command. Consequently, multiple electric window coverings on the same facade or within the same group of the building may stop at different heights after movement, resulting in misaligned lower rails. This misalignment leads to inconsistent shading heights across windows, creating a visually cluttered effect. This issue is particularly pronounced in electric window coverings featuring both a middle rail and a lower rail, such as day-night window coverings, where misalignment of the middle and lower rails further exacerbates the visual disarray. To rectify the visual appearance of the window covering shading, users must repeatedly fine-tune the height of each electric window covering individually to achieve uniform shading heights, thereby negating the convenience of group control.

When multiple lower rails and/or middle rails of electric window coverings within the same facade or group of the building fail to align after stopping or while remaining stationary, the arrangement may appear untidy and unattractive to users. Consequently, there is a pressing need for a technical solution that enables the automatic alignment of multiple lower rails and/or middle rails among electric window coverings within the same group.

### SUMMARY OF THE PRESENT INVENTION

From the foregoing, it is evident that the objective of the present disclosure is to provide an innovative electric window covering alignment technology. This technology enables multiple electric window coverings within the same group to exchange or transmit alignment packets when stopping or while remaining stationary. Each electric window covering determines whether to drive its lower rail and/or middle rail to move, as well as the position at which the lower rail and/or middle rail stops after movement, based on its current lower rail and/or middle rail position as well as the received positions of lower rail and/or middle rail of other electric window coverings. This process achieves automatic alignment of the lower rails and/or middle rails.

In accordance with one objective of the present disclosure, an embodiment provides a first electric window covering. The first electric window covering comprises an upper rail, a lower rail, a lower rail driving assembly, a control device, and a power supply unit. The lower rail is disposed below the upper rail and is driven to move relative to the upper rail between an upper limit position and a lower limit position. The lower rail driving assembly includes a lower rail motor and a lower rail encoder, wherein the lower rail encoder senses the rotation of the lower rail motor to generate a lower rail encoding signal representing the current position of the lower rail. The control device is electrically connected to the lower rail motor and the lower rail encoder and is configured to control the lower rail motor to drive the lower rail to move and to receive the lower rail encoding signal from the lower rail encoder. The power supply unit is electrically connected to the lower rail motor, the control device, and the lower rail encoder. Upon receiving a specific remote control command, the control device transmits a first alignment packet to a second electric window covering and receives a second alignment packet from the second electric window covering. The control device then controls the lower rail motor to align the lower rail based on the first and second alignment packets. The first alignment packet includes at least information about the current position of the lower rail of the first electric window covering when it is stopped or stationary, and the second alignment packet includes at least information about the current position of the lower rail of the second electric window covering when it is stopped or stationary.

In accordance with another objective of the present disclosure, an embodiment provides a window covering alignment method for a first electric window covering and a second electric window covering. The method comprises the following steps: after the control device of the first electric window covering receives a specific remote control command, the first electric window covering transmits a first alignment packet to the second electric window covering, wherein the first alignment packet includes information about the current position of the lower rail of the first electric window covering when it is stopped or stationary; after the control device of the second electric window covering receives the specific remote control command, the second electric window covering transmits a second alignment packet to the first electric window covering, wherein the second alignment packet includes information about the current position of the lower rail of the second electric window covering when it is stopped or stationary; the control device of the first electric window covering controls the lower rail motor of the first electric window covering to align the lower rail of the first electric window covering based on the first and second alignment packets; and the control device of the second electric window covering controls the lower rail motor of the second electric window covering to align the lower rail of the second electric window covering based on the first and second alignment packets.

In accordance with yet another objective of the present disclosure, an embodiment provides an electric window covering system. The electric window covering system includes the aforementioned first electric window covering and the aforementioned second electric window covering, wherein the second electric window covering is wirelessly connected to the first electric window covering.

In summary, compared to the prior art, the electric window covering, system, and window covering alignment method provided by the present disclosure enable the alignment of lower rails and/or middle rails when multiple electric window coverings stop or remain stationary. This eliminates the need for repeated adjustments and multiple control signal transmissions required for individually aligning the lower rails and/or middle rails of multiple electric window coverings.

### BRIEF DESCRIPTION OF THE DRAWINGS

FIG. 1 is a schematic diagram of a first electric window covering according to an embodiment of the present disclosure;

FIG. 2 is an enlarged schematic diagram of a lower rail motor and a control device of the first electric window covering according to an embodiment of the present disclosure;

FIG. 3 is a functional block diagram of the first electric window covering according to an embodiment of the present disclosure;

FIG. 4 is a schematic diagram of misaligned lower rails of a first electric window covering and a second electric window covering in a window covering system according to an embodiment of the present disclosure;

FIG. 5 is a schematic diagram of the first electric window covering applying a minimum scale alignment method according to an embodiment of the present disclosure;

FIG. 6 is a schematic diagram of the first electric window covering and the second electric window covering applying a propagation packet automatic alignment method according to an embodiment of the present disclosure;

FIG. 7 is a schematic diagram of another embodiment of the first electric window covering according to the present disclosure;

FIG. 8 is a partially enlarged schematic diagram of a lower rail motor, a middle rail motor, and a control device of another embodiment of the first electric window covering according to the present disclosure;

FIG. 9 is a schematic diagram of misaligned middle rails and lower rails of a first electric window covering and a second electric window covering in a window covering system according to an embodiment of the present disclosure; and

FIG. 10 is a flowchart of a window covering alignment method according to an embodiment of the present disclosure.

### DETAILED DESCRIPTION OF THE PREFERRED EMBODIMENTS

To enable multiple electric window coverings within the same group in a window covering system to automatically align their lower rails and/or middle rails after stopping, the electric window coverings of the present disclosure execute a propagation packet automatic alignment method. By propagating alignment packets containing information about the current position of their own lower rail and/or middle rail to other electric window coverings, each electric window covering can determine whether to move its lower rail and/or middle rail, as well as the direction and distance of movement, based on its own alignment packet and the alignment packets received from other electric window coverings. This process aligns the lower rails and/or middle rails of multiple electric window coverings. The propagation of alignment packets can be performed via broadcast, multicast, or unicast. In the case of multicast or unicast, it is typically necessary to set the address of each electric window covering, such as, but not limit to, an Internet Protocol (IP) address, and electric window coverings within the same group must be aware of each other's addresses to successfully transmit alignment packets to one another. Unicast is limited to situations where the electric window covering system consists of only two electric window coverings. Additionally, to increase alignment accuracy, multiple electric window coverings within the same group can also execute a minimum scale alignment method. The following provides a detailed description of possible embodiments of the present disclosure with reference to the accompanying drawings. It should be noted that the following implementation details are not intended to limit the scope of the patent claims of the present disclosure but are provided to facilitate understanding by those skilled in the art.

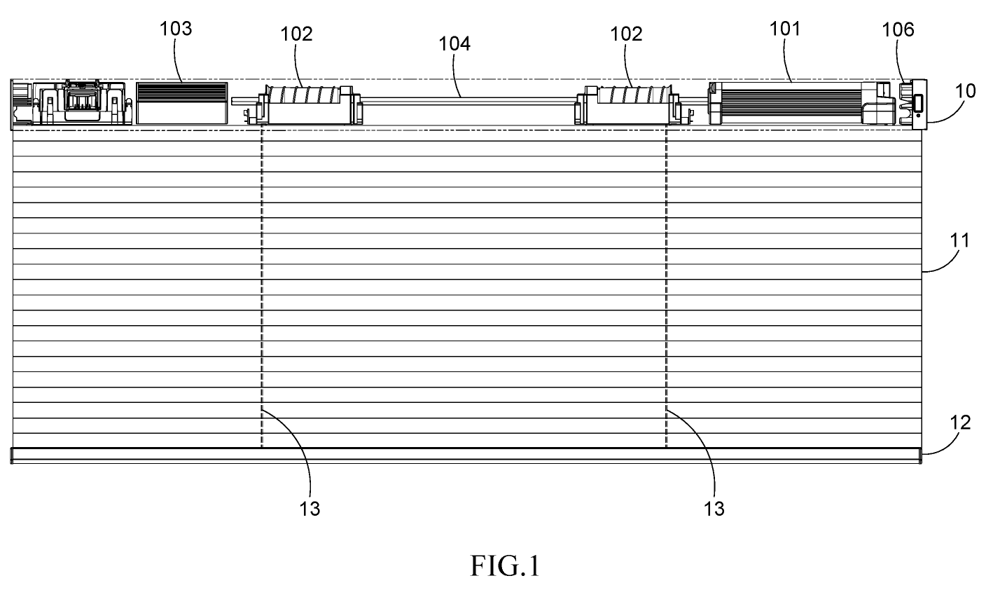

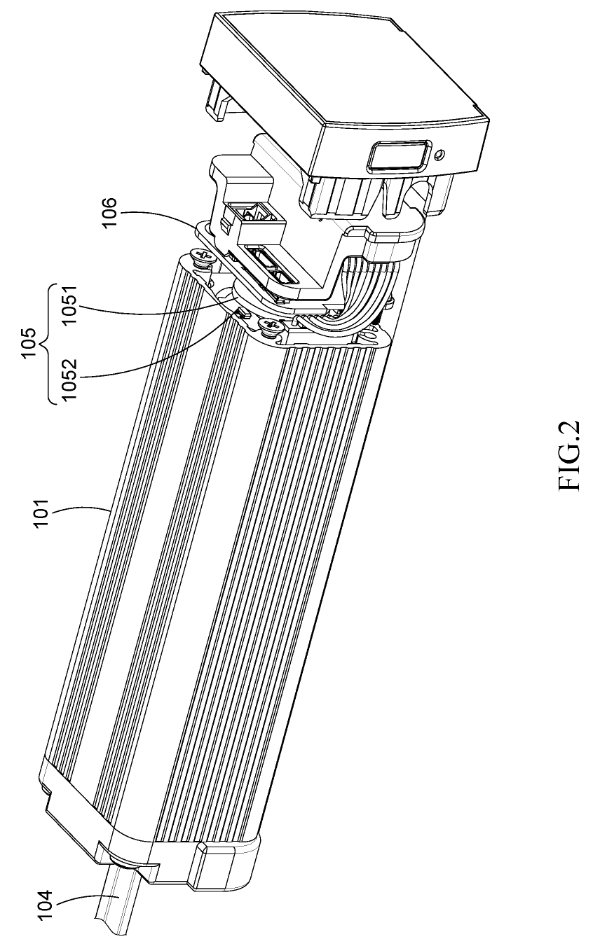

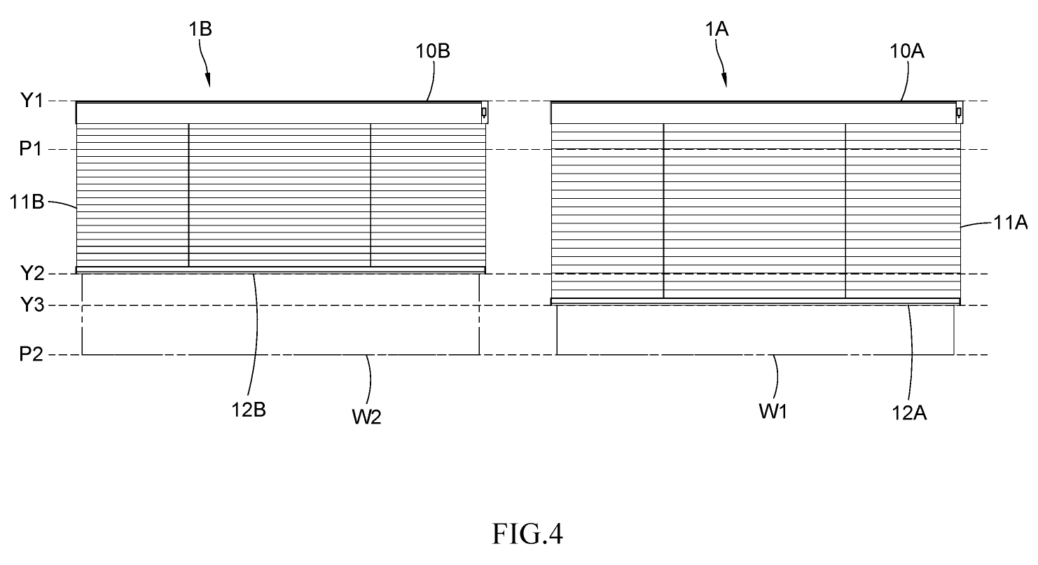

Referring to FIGS. 1 and 2, FIG. 1 is a schematic diagram of a first electric window covering according to an embodiment of the present disclosure, and FIG. 2 is an enlarged schematic diagram of a lower rail motor and a control device inside an upper rail of the first electric window covering according to an embodiment of the present disclosure. The first electric window covering comprises an upper rail 10, a lower rail 12, and a covering material 11. The lower rail 12 is disposed below the upper rail 10, and the covering material 11 is connected between the upper rail 10 and the lower rail 12. The internal space of the upper rail 10 is configured with a lower rail motor 101, a control device 106, a lower rail encoder 105, a lower rail cord spool 102, and a power supply unit 103. The power supply unit 103 is electrically connected to the lower rail motor 101, the control device 106, and the lower rail encoder 105. The control device 106 is electrically connected to the lower rail motor 101 and the lower rail encoder 105 and sets the upper limit position of the lower rail at height position P1 and the lower limit position at height position P2 (see FIG. 4). The lower rail motor 101, the lower rail cord spool 102, and the lower rail encoder 105 constitute a lower rail driving assembly, which drives the lower rail 12 to move relative to the upper rail 10 between the upper limit position P1 and the lower limit position P2.

The power supply unit 103 supplies DC power to the lower rail motor 101, the control device 106, and the lower rail encoder 105. The power supply unit 103 may be a rechargeable secondary battery, a replaceable primary battery, or an AC-to-DC adapter circuit connected to mains power, though the present disclosure is not limited to these options. The lower rail cord spool 102 is connected to the lower rail motor 101. The internal space of the upper rail 10 of the first electric window covering is further configured with a lower rail driving shaft 104, which connects the lower rail cord spool 102 and the lower rail motor 101. In this embodiment, there are two lower rail cord spools 102, and the two lower rail cord spools 102 are connected by the lower rail driving shaft 104, enabling the two lower rail cord spools 102 to rotate synchronously. The number of lower rail cords 13 corresponds to the number of lower rail cord spools 102, though the present disclosure is not limited to this number. One end of each lower rail cord 13 is connected to a lower rail cord spool 102, and the other end passes through the covering material 11 and is fixed to the lower rail 12. When the lower rail motor 101 rotates, it drives the lower rail cord spool 102 to rotate via the lower rail driving shaft 104, thereby winding or unwinding the lower rail cord 13 connected to the lower rail cord spool 102. When the lower rail cord 13 is wound or unwound by the lower rail cord spool 102, it drives the lower rail 12 to move between the upper limit position P1 and the lower limit position P2 (see FIG. 4).

The lower rail encoder 105 is primarily used to senses the rotation of the lower rail motor 101 to generate a lower rail encoding signal. Specifically, the lower rail encoder 105 includes a lower rail magnetic wheel 1051 and a lower rail magnetic sensor 1052. The lower rail magnetic wheel 1051 is connected to the lower rail motor 101. When the lower rail motor 101 drives the lower rail driving shaft 104 to rotate, it also drives the lower rail magnetic wheel 1051 to rotate. The lower rail magnetic sensor 1052 is fixed to the lower rail motor 101 and is positioned near the periphery of the lower rail magnetic wheel 1051. The lower rail magnetic sensor 1052 is electrically connected to the control device 106. The lower rail magnetic sensor 1052 senses the changes in magnetic force through the rotation of the lower rail magnetic wheel 1051, thereby sensing the rotation of the lower rail motor 101 and generating a lower rail encoding signal representing the current position of the lower rail. The lower rail magnetic sensor 1052 may be, but is not limited to, a Hall sensor. Additionally, the lower rail encoder 105 may also be implemented applying other methods, such as an optical encoder that detects motion optically.

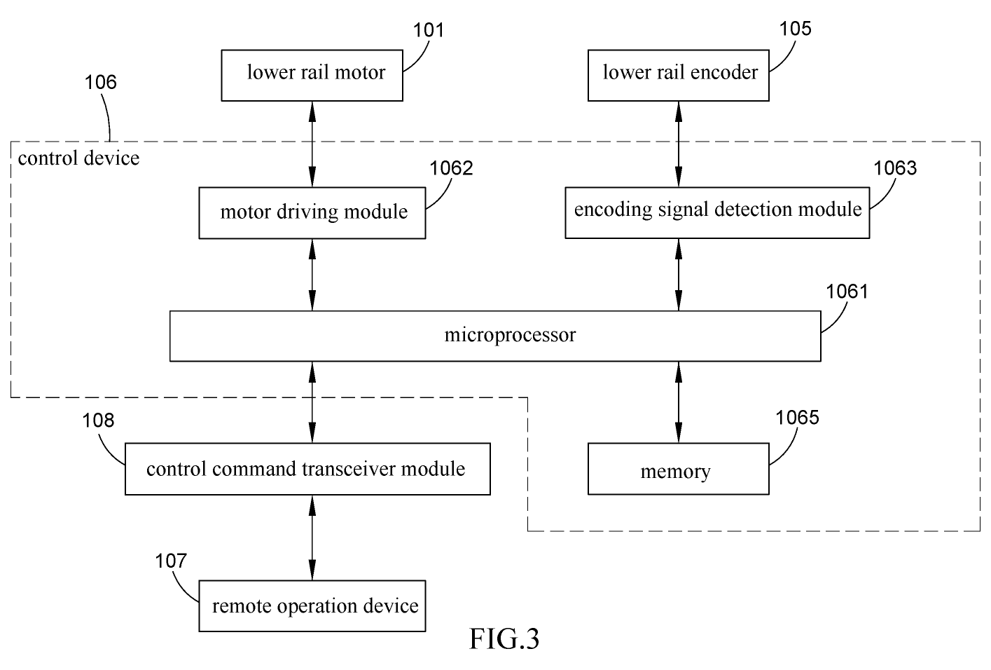

Referring to FIG. 3, FIG. 3 is a functional block diagram of the first electric window covering according to an embodiment of the present disclosure. The control device 106 of the first electric window covering includes a motor driving module 1062, a microprocessor 1061, an encoding signal detection module 1063, and a memory 1065. The microprocessor 1061 is electrically connected to the motor driving module 1062, the encoding signal detection module 1063, a control command transceiver module 108, and the memory 1065. The motor driving module 1062 is electrically connected to the lower rail motor 101. The microprocessor 1061 transmits a driving signal to the motor driving module 1062, causing the motor driving module 1062 to control the rotation or stopping of the lower rail motor 101 based on the driving signal. Additionally, the control command transceiver module 108 is electrically connected to the power supply unit 103, w hich is used to provide power to the control command transceiver module 108.

The encoding signal detection module 1063 is electrically connected to the lower rail encoder 105 and checks the integrity of the lower rail encoding signal. The microprocessor 1061 receives the lower rail encoding signal from the encoding signal detection module 1063 to obtain the current position of the lower rail 12 of the first electric window covering when it is stopped or stationary. The memory 1065 serves as an external cache space for data of the microprocessor 1061. The first electric window covering may further include a remote operation device 107. The control command transceiver module 108 is communicatively connected to the remote operation device 107. In this embodiment, the remote operation device 107 may be a remote wireless operation device operated by the user to generate a wireless remote control command, which is transmitted to the control command transceiver module 108. The control command transceiver module 108 then transmits the wireless remote control command to the microprocessor 1061. In other embodiments, the remote operation device 107 may be a central control panel that generates a remote control command based on user settings or inputs from environmental sensors (e.g., ambient light sensors) and transmits the remote control command to the control command transceiver module 108 via wired or wireless means. The control command transceiver module 108 then transmits the remote control command to the microprocessor 1061. In this embodiment, the microprocessor 1061 serves as the core of the control device 106 and executes control commands for aligning, moving, and stopping the lower rail 12.

The covering material 11 varies depending on the type of the first electric window covering. In this embodiment, the first electric window covering is an electric honeycomb shade, and the covering material 11 may be a series of hollow window covering sheet with a hexagonal cross-section (not shown) disposed between the upper rail 10 and the lower rail 12. In other embodiments, the first electric window covering may be an electric blind, and the covering material 11 may be a series of blind slats disposed between the upper rail 10 and the lower rail 12, parallel to each other and to the upper rail 10 and the lower rail 12. In this embodiment, the lower rail driving assembly, the power supply unit 103, and the control device 106 are disposed within the internal space of the upper rail 10. In other embodiments, part or all of the lower rail driving assembly, the power supply unit 103, and the control device 106 may be disposed within the internal space of the lower rail 12 or outside the upper rail 10 and the lower rail 12 but near the covering material 11.

The control device 106 controls the lower rail motor 101 to drive the lower rail cord spool 102 to rotate, thereby unwinding or winding the lower rail cord 13 to drive the lower rail 12 to descend or ascend, causing the covering material 11 to expand or retract. The control device 106 can also obtain the current position of the lower rail 12 based on the lower rail encoding signal from the lower rail magnetic sensor 1052, especially when the lower rail 12 has completed its movement and stopped or is stationary. When the control device 106 receives a specific remote control command via the control command transceiver module 108, the control device 106 propagates a first alignment packet to a second electric window covering within the same group and receives a second alignment packet from the second electric window covering. The control device 106 then controls the lower rail motor 101 to align the lower rail 12 based on the first and second alignment packets. The first alignment packet includes information about the current position of the lower rail 12 of the first electric window covering when it is stopped or stationary, and the second alignment packet includes information about the current position of the lower rail of the second electric window covering when it is stopped or stationary. It should be noted that the first electric window covering and the second electric window covering have the same structure, and thus the structure of the second electric window covering will not be described in detail here.

The above embodiment describes two electric window coverings with identical structures and vertical heights within the same group. However, in other embodiments, the electric window covering system may include three or more electric window coverings with identical structures and vertical heights within the same group. In such cases, the control device 106 of the first electric window covering propagates the first alignment packet to the second to N^{th} electric window coverings within the same group and receives the second to N^{th} alignment packets propagated by the control devices of the second to N^{th} electric window coverings. The control device 106 of the first electric window covering then controls the lower rail motor 101 to align the lower rail 12 based on the first to N^{th} alignment packets. The first alignment packet includes information about the current position of the lower rail 12 of the first electric window covering when it is stopped or stationary, and the second to N^{th} alignment packets respectively include information about the current positions of the lower rails of the second to N^{th} electric window coverings when they are stopped or stationary, where N is an integer greater than or equal to 3.

Referring to FIG. 4, FIG. 4 is a schematic diagram of misaligned lower rails of two electric window coverings in a window covering system according to an embodiment of the present disclosure. The window covering system includes at least two electric window coverings, a first electric window covering 1A and a second electric window covering 1B, belonging to the same group. The first electric window covering 1A and the second electric window covering 1B are respectively located on windows W1 and W2, which have the same height dimensions on the vertical axis, and can communicate with each other. Each of the first electric window covering 1A and the second electric window covering 1B includes the same components as the first electric window covering shown in FIGS. 1 to 3. In this embodiment, the upper rail 10A of the first electric window covering 1A and the upper rail 10B of the second electric window covering 1B are configured at height position Y1 on the vertical axis, meaning that the first electric window covering 1A and the second electric window covering 1B are installed at a fixed height position Y1. Since the first electric window covering 1A and the second electric window covering 1B are installed at the same height on the windows W1 and W2, the upper limit positions P1 and the lower limit positions P2 of the lower rails 12A and 12B of the first electric window covering 1A and the second electric window covering 1B, respectively, will also be the same. Each of the lower rails 12A and 12B can move between its own upper limit position P1 and lower limit position P2.

When the control devices of the first electric window covering 1A and the second electric window covering 1B receive a remote control command to move the lower rails 12A and 12B downward, the control devices of the first electric window covering 1A and the second electric window covering 1B control their respective lower rail motors to move their lower rails 12A and 12B downward relative to the upper rails 10A and 10B. Then, when the control devices of the first electric window covering 1A and the second electric window covering 1B receive a specific remote control command, such as a stop command, they control their lower rail motors to stop the movement of the lower rails 12A and 12B. Due to environmental factors, the control devices of the first electric window covering 1A and the second electric window covering 1B may receive the movement command and/or the stop command at different times, causing the lower rails 12A and 12B of the first electric window covering 1A and the second electric window covering 1B to start moving and/or stop moving at different times. As a result, when the lower rails 12A and 12B stop moving, they stop at height positions Y3 and Y2, respectively.

Through the lower rail encoding signal generated by the lower rail encoder of the first electric window covering 1A, which represents the current position of the lower rail 12A of the first electric window covering 1A when it is stopped or stationary, the control device of the first electric window covering 1A identifies that its lower rail is currently at height position Y3. Similarly, through the lower rail encoding signal generated by the lower rail encoder of the second electric window covering 1B, which represents the current position of the lower rail 12B of the second electric window covering 1B when it is stopped or stationary, the control device of the second electric window covering 1B identifies that its lower rail is currently at height position Y2. However, at this point, the first electric window covering 1A is not aware the current position of the lower rail of the second electric window covering 1B, and the second electric window covering 1B is not aware the current position of the lower rail of the first electric window covering 1A. As can be seen from FIG. 4, the lower rails 12 of the first electric window covering 1A and the second electric window covering 1B are not aligned, which does not meet the user's expectations. Therefore, the control devices of the first electric window covering 1A and the second electric window covering 1B will execute the propagation packet automatic alignment method. The control device of the first electric window covering 1A generates and propagates a first alignment packet to the second electric window covering 1B, and the control device of the second electric window covering 1B generates and propagates a second alignment packet to the first electric window covering 1A. The first alignment packet includes information about the current position of the lower rail 12A of the first electric window covering 1A when it is stopped or stationary, and the second alignment packet includes information about the current position of the lower rail 12B of the second electric window covering 1B when it is stopped or stationary. The control devices of the first electric window covering 1A and the second electric window covering 1B can independently determine that the current positions of their lower rails are at height positions Y3 and Y2, respectively, based on the first and second alignment packets, and proceed to automatically align the lower rails 12A and 12B. In this example, the lower rail 12B of the second electric window covering 1B remains at height position Y2, and the lower rail 12A of the first electric window covering 1A moves upward to height position Y2. Alternatively, the lower rail 12A of the first electric window covering 1A remains at height position Y3, and the lower rail 12B of the second electric window covering 1B moves downward to height position Y3. Preferably, the control devices of the first electric window covering 1A and the second electric window covering 1B further control their lower rail motors to align the lower rails 12A and 12B based on the first alignment packet, the second alignment packet, and the previous movement directions of their lower rails 12A and 12B. Therefore, the lower rail 12A of the first electric window covering 1A remains at height position Y3, and the lower rail 12B of the second electric window covering 1B moves downward to height position Y3, causing both the lower rail 12A of the first electric window covering 1A and the lower rail 12B of the second electric window covering 1B to stop at height position Y3, achieving alignment of the lower rails 12A and 12B.

In the above example, the upper limit positions P1 of the lower rails of the first electric window covering 1A and the second electric window covering 1B, respectively, are configured at a first upper initial height position, and the distances between the current positions of the lower rails and the first upper initial height position define the movement distances of the respective lower rails. When the movement distances of the lower rails of the first electric window covering 1A and the second electric window covering 1B are the same, the lower rails 12A and 12B will be at the same height. Therefore, the lower limit positions P2 of the lower rails of the first electric window covering 1A and the second electric window covering 1B may be the same or different, meaning that the height dimensions of the windows W1 and W2 on the vertical axis may also be the same or different. Additionally, in some cases, the upper limit positions P1 of the lower rails of the first electric window covering 1A and the second electric window covering 1B may not be aligned at the same vertical height, but the lower limit positions P2 of the lower rails of the first electric window covering 1A and the second electric window covering 1B may be aligned at the same vertical height. In such cases, the lower limit positions P2 of the lower rails of the first electric window covering 1A and the second electric window covering 1B are configured at a first lower initial height position, and the distances between the current positions of the lower rails and the first lower initial height position define the movement distances of the respective lower rails. When the movement distances of the lower rails of the first electric window covering 1A and the second electric window covering 1B are the same, the lower rails 12A and 12B will be at the same height. Therefore, the upper limit positions P1 of the lower rails of the first electric window covering 1A and the second electric window covering 1B may be the same or different, meaning that the height dimensions of the windows W1 and W2 on the vertical axis may also be the same or different.

Furthermore, the above example describes aligning the lower rails 12 after receiving a stop command as the specific remote control command, but the present disclosure is not limited to this. In one embodiment, the control devices of the first electric window covering 1A and the second electric window covering 1B may receive a specific remote control command, such as a command to move the lower rails 12A and 12B to a specified height position, and after the lower rails 12A and 12B have moved to the specified height position and stopped, the control devices of the first electric window covering 1A and the second electric window covering 1B automatically execute the aforementioned propagation packet automatic alignment method. In another embodiment, the lower rails 12A and 12B of the electric window coverings 1A and 1B may have been stationary for a period of time, and the control devices of the first electric window covering 1A and the second electric window covering 1B may execute the propagation packet automatic alignment method after receiving a specific remote control command for active alignment.

Additionally, each of the first alignment packet and the second alignment packet may further include information such as the window covering type, group code, etc. Only electric window coverings of the same type and within the same group will align their lower rails 12A and 12B. In other words, the control devices of the first electric window covering 1A and the second electric window covering 1B will compare and determine whether to discard alignment packets from different window covering types or different groups, and discarded alignment packets will not be used as the basis for controlling the alignment of the lower rails 12A and 12B. Moreover, the first alignment packet may further include information about the maximum movement distance of the lower rail of the first electric window covering 1A between the upper limit position P1 and the lower limit position P2, and a predetermined maximum alignment distance of the lower rail. The maximum movement distance of the lower rail refers to the maximum distance that the lower rail 12A of the first electric window covering 1A can move (i.e., the distance between the upper limit position P1 and the lower limit position P2 of the lower rail of the first electric window covering 1A). The maximum alignment distance of the lower rail refers to the maximum distance that the lower rail 12A of the first electric window covering 1A can move during alignment, which may be a preset distance or a percentage of the maximum movement distance of the lower rail. Similarly, the second alignment packet may further include information about the maximum movement distance of the lower rail of the second electric window covering 1B between the upper limit position P1 and the lower limit position P2, and a predetermined maximum alignment distance of the lower rail. The maximum movement distance of the lower rail refers to the maximum distance that the lower rail 12B of the second electric window covering 1B can move (i.e., the distance between the upper limit position P1 and the lower limit position P2 of the lower rail of the second electric window covering 1B). The maximum alignment distance of the lower rail refers to the maximum distance that the lower rail 12B of the second electric window covering 1B can move during alignment, which may be a preset distance or a percentage of the maximum movement distance of the lower rail. The maximum movement distances of the lower rails of the first electric window covering 1A and the second electric window covering 1B may be the same or different, and similarly, the maximum alignment distances of the lower rails may also be the same or different.

In an electric window covering system that includes three electric window coverings, when the control device of the first electric window covering 1A determines that the difference between its maximum movement distance of the lower rail and the maximum movement distance of the lower rail in the second alignment packet received from the second electric window covering exceeds a predetermined threshold, the control device of the first electric window covering 1A will discard the second alignment packet, and the discarded second alignment packet will not be used as the basis for controlling the alignment of the lower rail 12A. Instead, the control device of the first electric window covering will use the first alignment packet and a third alignment packet provided by a third electric window covering to align the lower rail 12A. Similarly, when the control device of the second electric window covering 1B determines that the difference between its maximum movement distance and the maximum movement distance of the lower rail in the first alignment packet received from the first electric window covering exceeds a predetermined threshold, the control device of the second electric window covering 1B will discard the first alignment packet, and the discarded first alignment packet will not be used as the basis for controlling the alignment of the lower rail 12B. Instead, the control device of the second electric window covering will use the second alignment packet and a third alignment packet provided by a third electric window covering to align the lower rail 12B.

In another embodiment, it may be configured such that only electric window coverings that are of the same type, within the same group, and with the same maximum movement distance of the lower rail are allowed to align their lower rails 12A and 12B. Additionally, when the distance that the lower rail 12A of the first electric window covering 1A needs to move to reach the lower rail alignment height position exceeds the maximum alignment distance of the lower rail of the first electric window covering 1A, the control device of the first electric window covering 1A will not perform the alignment of the lower rail 12A.

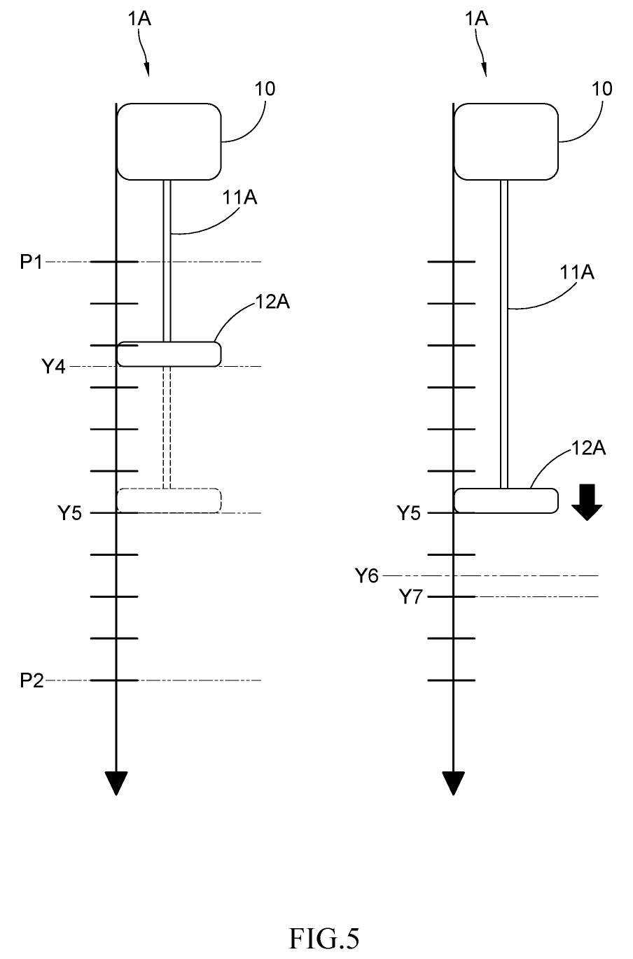

Referring to FIG. 5, FIG. 5 is a schematic diagram of the first electric window covering applying a minimum scale alignment method according to an embodiment of the present disclosure. To make the alignment of the lower rail 12A more precise, in addition to executing the propagation packet automatic alignment method, the control device of the electric window covering may also execute the minimum scale alignment method. In the left side of FIG. 5, the first electric window covering 1A receives a specific remote control command to move the lower rail 12A downward by a certain distance when the lower rail 12A is at height position Y4. The control device of the first electric window covering 1A is configured to recalculate a target height position that is an integer multiple of the minimum scale, such as height position Y5, based on the distance that the lower rail 12A is required to move, and to control movement of the lower rail 12A of the first electric window covering 1A to the height position Y5, which is an integer multiple of the minimum scale. The minimum scale may be, but is not limited to, a distance corresponding to ten rotations of the lower rail motor.

In contrast to the scenario on the left side of FIG. 5, the scenario on the right side of FIG. 5 illustrates the electric window covering 1A receives a remote control command without a specified height position, whereby the user visually observes the movement of the lower rail 12A. When the user observes that the lower rail 12A has moved to a desired height position, such as height position Y5, the electric window covering 1A receives a specific remote control command to stop. In the absence of the minimum scale alignment method, the control device of the electric window covering would plan a target position, designated as height position Y6, based on the current speed of the lower rail motor and the deceleration mechanism; however, height position Y6 does not correspond to an integer multiple of the minimum scale. After applying the minimum scale alignment method, the control device of the electric window covering is configured to adjust the target position to height position Y7, which is an integer multiple of the minimum scale. In simple terms, when applying the minimum scale alignment method, the final stopping height position of the lower rail 12 will only be an integer multiple of the minimum scale.

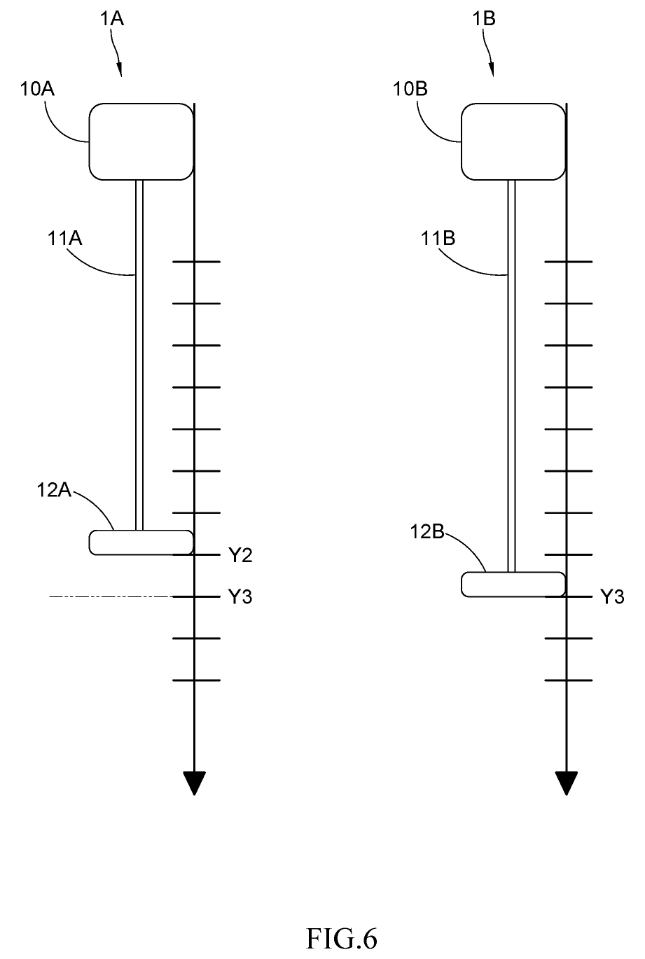

Referring to FIG. 6, FIG. 6 is a schematic diagram of the first electric window covering and the second electric window covering applying the propagation packet automatic alignment method according to an embodiment of the present disclosure. Due to the application of the minimum scale alignment method, after the control devices of the first electric window covering 1A and the second electric window covering 1B sequentially receive a movement command and a stop command as two remote control commands, the lower rails 12 of the first electric window covering 1A and the second electric window covering 1B stop at height positions Y2 and Y3, respectively, wherein each of the height positions Y2 and Y3 is an integer multiple of the minimum scale. Then, the control devices of the electric window coverings 1A and 1B execute the aforementioned propagation packet automatic alignment method. The control device of the first electric window covering 1A controls its lower rail motor to move the lower rail 12A downward to the height position Y3, based on the received second alignment packet from the second electric window covering 1B and its own first alignment packet. Meanwhile, the control device of the second electric window covering 1B does not move its lower rail 12B, based on the received first alignment packet from the first electric window covering 1A and its own second alignment packet. In simple terms, after automatic alignment, the lower rails 12 of the first electric window covering 1A and the second electric window covering 1B are at a lower rail alignment height position, which is an integer multiple of the minimum scale.

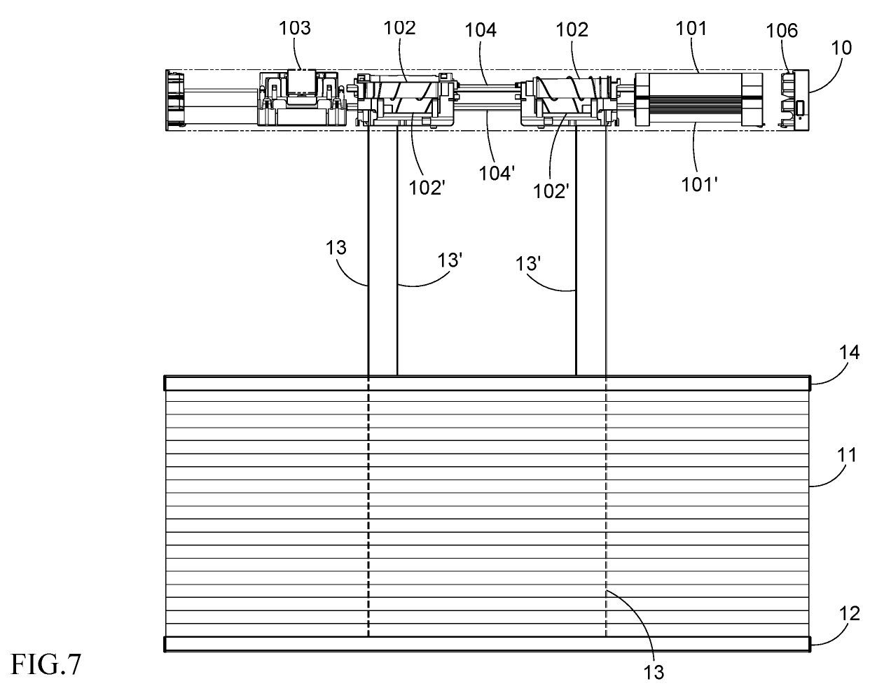

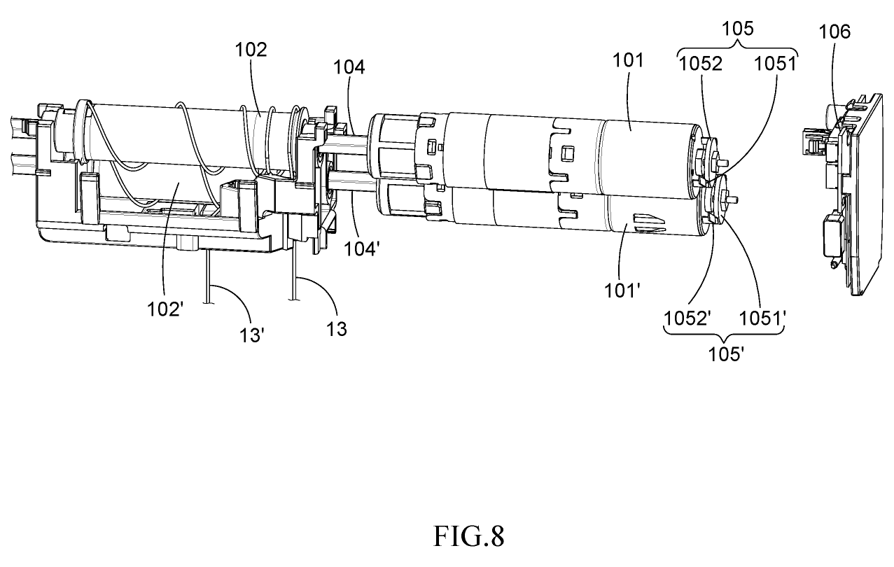

Referring to FIGS. 7 and 8, FIG. 7 is a schematic diagram of another embodiment of the first electric window covering according to the present disclosure, and FIG. 8 is a partially enlarged schematic diagram of a lower rail motor, a middle rail motor, and a control device of another embodiment of the first electric window covering according to the present disclosure. Unlike the first electric window covering shown in FIGS. 1 and 2, in this embodiment, the first electric window covering further includes a middle rail 14 disposed between the upper rail 10 and the lower rail 12. The internal space of the upper rail 10 is further configured with a middle rail motor 101’, a middle rail cord spool 102’, and a middle rail encoder 105’. The middle rail encoder 105’ can sense the rotation of the middle rail motor 101’ to generate a middle rail encoding signal. The middle rail encoder 105’ includes a middle rail magnetic wheel 1051’ connected to the middle rail motor 101’ and a middle rail magnetic sensor 1052' fixed to the middle rail motor 101’ and positioned near the periphery of the middle rail magnetic wheel 1051’. Additionally, the middle rail motor 101’, the middle rail cord spool 102’, and the middle rail encoder 105’ constitute a middle rail driving assembly, which can drive the middle rail 14 to move relative to the upper rail 10 between an upper limit position and a lower limit position of the middle rail.

The power supply unit 103 is electrically connected to the middle rail motor 101’ and the middle rail encoder 105’ to provide DC power to the middle rail motor 101’ and the middle rail encoder 105’. The control device 106 is electrically connected to the middle rail motor 101’ and the middle rail encoder 105’ to control the rotation of the middle rail motor 101’ and receive the middle rail encoding signal generated by the middle rail encoder 105’. The middle rail motor 101’ is connected to the two middle rail cord spools 102’ via a middle rail driving shaft 104’, enabling the two middle rail cord spools 102’ to rotate synchronously when driven by the middle rail motor 101’. The two middle rail cord spools 102’ are respectively connected to the middle rail 14 via two middle rail cords 13’. One end of each middle rail cord 13’ is connected to a middle rail cord spool 102’, and the other end is fixed to the middle rail 14. When the control device 106 controls the middle rail motor 101’ to rotate, causing the middle rail cord spools 102’ to wind or unwind the middle rail cords 13’, the middle rail 14 moves relative to the upper rail 10 between the upper limit position and the lower limit position of the middle rail. Since the middle rail encoder 105’ can sense the rotation of the middle rail motor 101’, when the control device 106 controls the middle rail motor 101’ to stop, the middle rail encoder 105’ generates a middle rail encoding signal representing the current position of the middle rail 14 of the first electric window covering when the middle rail 14 is stopped or stationary. In this embodiment, the covering material 11 is connected between the middle rail 14 and the lower rail 12, or alternatively, a covering material may be connected between the middle rail 14 and the lower rail 12, and another covering material may be connected between the upper rail 10 and the middle rail 14 (not shown).

In this embodiment, the middle rail driving assembly is disposed within the internal space of the upper rail 10. However, in other embodiments, part or all of the middle rail driving assembly may be disposed within the internal space of the lower rail 12 or the middle rail 14, or outside the upper rail 10, the lower rail 12, and the middle rail 14 but near the covering material.

After the middle rail 14 and the lower rail 12 of the first electric window covering have moved and stopped (e.g., after the control device 106 sequentially receives a movement command and a stop command, or receives a command to directly move the middle rail 14 and the lower rail 12 to a specified position), or after the middle rail 14 and the lower rail 12 of the first electric window covering have been stationary for a period of time, the control device 106 receives a specific remote control command for active alignment and executes the propagation packet automatic alignment method. The first alignment packet includes not only information about the current position of the lower rail 12 of the first electric window covering when the lower rail 12 is stopped or stationary but also information about the current position of the middle rail 14 of the first electric window covering when the middle rail 14 is stopped or stationary. Similarly, the second alignment packet includes not only information about the current position of the lower rail 12 of the second electric window covering when the lower rail is stopped or stationary but also information about the current position of the middle rail 14 of the second electric window covering when the middle rail is stopped or stationary. Therefore, the first electric window covering can control its lower rail motor 101 and middle rail motor 101’ to align its lower rail 12 and middle rail 14 based on the second alignment packet received from the second electric window covering and its own first alignment packet. Similarly, the second electric window covering can control its lower rail motor and middle rail motor to align its lower rail and middle rail based on the first alignment packet received from the first electric window covering and its own second alignment packet.

It should be noted that in one scenario, the upper limit position of the lower rail of the first electric window covering and the upper limit position of the lower rail of the second electric window covering are aligned at a first upper initial height position, and the distances between the current positions of the lower rails and the first upper initial height position define the movement distances of the respective lower rails. Additionally, the upper limit position of the middle rail of the first electric window covering and the upper limit position of the middle rail of the second electric window covering are aligned at a second upper initial height position, and the distances between the current positions of the middle rails and the second upper initial height position define the movement distances of the respective middle rails. In another scenario, the lower limit position of the lower rail of the first electric window covering and the lower limit position of the lower rail of the second electric window covering are aligned at a first lower initial height position, and the distances between the current positions of the lower rails and the first lower initial height position define the movement distances of the respective lower rails. Additionally, the lower limit position of the middle rail of the first electric window covering and the lower limit position of the middle rail of the second electric window covering are aligned at a second lower initial height position, and the distances between the current positions of the middle rails and the second lower initial height position define the movement distances of the respective middle rails.

Furthermore, if the minimum scale alignment method is applied, the middle rail alignment height position relative to the second upper initial height position or the second lower initial height position will be an integer multiple of the minimum scale, and the lower rail alignment height position relative to the first upper initial height position or the first lower initial height position will also be an integer multiple of the minimum scale. In other words, after executing the propagation packet automatic alignment method, the lower rail 12 will be at a lower rail alignment height position, and the middle rail 14 will be at a middle rail alignment height position, with each of the lower rail alignment height position and the middle rail alignment height position being an integer multiple of the minimum scale. Additionally, in addition to aligning the middle rails 14 of the first and the second electric window coverings based on the aforementioned first alignment packet and second alignment packet, the control device 106 may also consider the previous movement directions of the middle rails 14 when performing the alignment. Moreover, the first alignment packet may further include information about the maximum movement distance of the lower rail of the first electric window covering between the upper limit position and the lower limit position of the lower rail, a predetermined maximum alignment distance of the lower rail (i.e., the maximum distance of the lower rail can move from its current position to the alignment height position of the lower rail), the maximum movement distance of the middle rail of the first electric window covering between the upper limit position and the lower limit position of the middle rail, and a predetermined maximum alignment distance of the middle rail (i.e., the maximum distance of the middle rail can move from its current position to the alignment height position of the middle rail). Similarly, the second alignment packet may further include information about the maximum movement distance of the lower rail of the second electric window covering between the upper limit position and the lower limit position of the lower rail, a predetermined maximum alignment distance of the lower rail (i.e., the maximum distance of the lower rail can move from its current position to the alignment height position of the lower rail), the maximum movement distance of the middle rail of the second electric window covering between the upper limit position and the lower limit position of the middle rail, and a predetermined maximum alignment distance of the middle rail (i.e., the maximum distance of the middle rail can move from its current position to the alignment height position of the middle rail). In an electric window covering system with three or more electric window coverings, when performing the alignment of the middle rail 14 and the lower rail 12, the control device 106 may also determine whether to discard the second alignment packet based on the information included in the second alignment packet and not use the discarded second alignment packet as the basis for aligning the middle rail 14 and the lower rail 12. For example, if the electric window covering system further includes a third electric window covering, the control device 106 of the first electric window covering may determine to discard the second alignment packet from the second electric window covering, and perform alignment of the middle rail 14 and the lower rail 12 of the first electric window covering based on the first alignment packet of the first electric window covering and a third alignment packet from the third electric window covering.

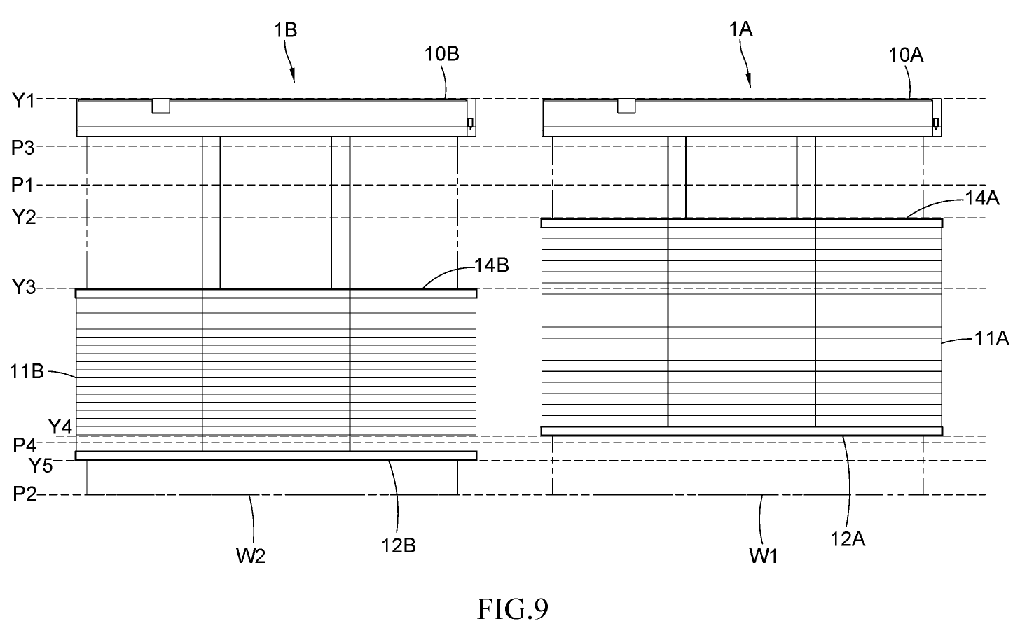

Referring to FIG. 9, FIG. 9 is a schematic diagram of misaligned middle rails and lower rails of a first electric window covering and a second electric window covering in a window covering system according to an embodiment of the present disclosure. In this embodiment, the upper rails 10A and 10B of the first electric window covering 1A and the second electric window covering 1B are configured at height position Y1 on the vertical axis and aligned at height position Y1. The lower rails 12A and 12B can move between their respective upper limit positions P1 and lower limit positions P2 of the lower rails, and the middle rails 14A and 14B can move between their respective upper limit positions P3 and lower limit positions P4 of the middle rails. When the control devices of the first electric window covering 1A and the second electric window covering 1B receive a control command, such as a command to move the middle rails 14A and 14B and the lower rails 12A and 12B downward, the control devices of the first electric window covering 1A and the second electric window covering 1B control their respective lower rail motors and middle rail motors to drive their lower rails 12A and 12B, and middle rails 14A and 14B downward. Then, when the control devices of the electric window coverings 1A and 1B receive a specific remote control command to stop, they control their respective lower rail motors and middle rail motors to stop the movement of their lower rails 12A and 12B and middle rails 14A and 14B. At this point, due to differences in the times at which commands are received by the first and second electric window coverings, respectively, the lower rails 12A and 12B of the first and second electric window covering 1A and 1B stop at positions Y4 and Y5, respectively, while the middle rails 14A and 14B of the first and second electric window covering 1A and 1B stop at height positions Y2 and Y3, respectively.

Based on the lower rail encoding signal and the middle rail encoding signal of the first electric window covering 1A, the control device of the first electric window covering 1A determines that the current position of the lower rail 12A is at height position Y4 when it is stopped or stationary , and the current position of the middle rail 14A is at height position Y2 when it is stopped or stationary. Similarly, based on the lower rail encoding signal and the middle rail encoding signal of the second electric window covering 1B, the control device of the second electric window covering 1B determines that the current position of the lower rail 12B is at height position Y5 when it is stopped or stationary, and the current position of the middle rail 14B is at height position Y3 when it is stopped or stationary. However, as can be clearly seen from FIG. 9, the lower rails 12A and 12B of the first electric window covering 1A and the second electric window covering 1B are not aligned, and the middle rails 14A and 14B of the first electric window covering 1A and the second electric window covering 1B are also not aligned. This results in a cluttered shading pattern between the adjacent first electric window covering 1A and second electric window covering 1B, which does not meet the user's expectations and affects visual aesthetics. At this point, the control devices of the first electric window covering 1A and the second electric window covering 1B in the embodiment of the present disclosure will be configured to execute the propagation packet automatic alignment method. The control device of the first electric window covering 1A generates and propagates a first alignment packet to the second electric window covering 1B, and the control device of the second electric window covering 1B generates and propagates a second alignment packet to the first electric window covering 1A. The first alignment packet includes information about the current position of the lower rail 12A and the middle rail 14A of the first electric window covering 1A, and the second alignment packet includes information about the current position of the lower rail 12B and the middle rail 14B of the second electric window covering 1B. The control devices of the first electric window covering 1A and the second electric window covering 1B align the lower rails 12A and 12B and the middle rails 14A and 14B based on the first alignment packet and the second alignment packet. In this embodiment, either the lower rail 12A of the first electric window covering 1A will move downward to height position Y5, or the lower rail 12B of the second electric window covering 1B will move upward to height position Y4. Similarly, either the middle rail 14A of the first electric window covering 1A will move downward to height position Y3, or the middle rail 14B of the second electric window covering 1B will move upward to height position Y2. Preferably, based on the previous movement directions of the middle rails 14A and 14B and the lower rails 12A and 12B, the lower rail 12A of the first electric window covering 1A will move downward to height position Y5, and the middle rail 14A of the first electric window covering 1A will move downward to height position Y3.

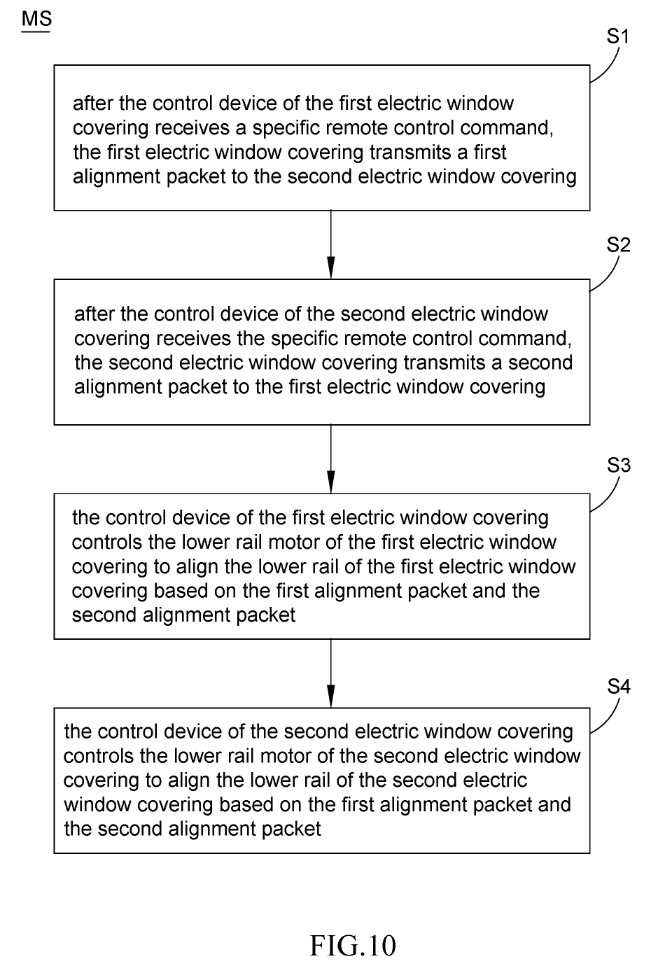

Based on the above, the present disclosure further provides a window covering alignment method. Referring to FIG. 10., FIG. 10 is a flowchart of a window covering alignment method according to an embodiment of the present disclosure. This window covering alignment method (MS) is applied in an electric window covering system that includes a first electric window covering and a second electric window covering. The method includes the following steps: in step S1, after the control device of the first electric window covering receives a specific remote control command, the first electric window covering transmits a first alignment packet to the second electric window covering, where the first alignment packet includes information about the current position of the lower rail of the first electric window covering when it is stopped or stationary; in step S2, after the control device of the second electric window covering receives the specific remote control command, the second electric window covering transmits a second alignment packet to the first electric window covering, where the second alignment packet includes information about the current position of the lower rail of the second electric window covering when it is stopped or stationary; in step S3, the control device of the first electric window covering controls the lower rail motor of the first electric window covering to align the lower rail of the first electric window covering based on the first alignment packet and the second alignment packet; and in step S4, the control device of the second electric window covering controls the lower rail motor of the second electric window covering to align the lower rail of the second electric window covering based on the first alignment packet and the second alignment packet. Additionally, the specific remote control command may be a stop command, an active alignment command, or a specified position command. Furthermore, the order of steps S1 and S2 is not intended to limit the present disclosure, meaning that step S2 may occur before step S1 or be executed simultaneously. Similarly, the order of steps S3 and S4 is not intended to limit the present disclosure, meaning that step S4 may occur before step S3 or be executed simultaneously.

In the above method, the first alignment packet further includes information about the current position of the middle rail of the first electric window covering when it is stopped or stationary, and the second alignment packet further includes information about the current position of the middle rail of the second electric window covering when it is stopped or stationary. In steps S3 and S4, the control devices of the first electric window covering and the second electric window covering independently control their respective lower rail motors to align their lower rails based on the first alignment packet and the second alignment packet, and independently control their respective middle rail motors to align their middle rails based on the first alignment packet and the second alignment packet.

In the above method, the upper limit position of the lower rail of the first electric window covering and the upper limit position of the lower rail of the second electric window covering are aligned at a first upper initial height position, and the distance between the current position of the lower rail of the first electric window covering and the first upper initial height position is the movement distance of the lower rail of the first electric window covering, and the distance between the current position of the lower rail of the second electric window covering and the first upper initial height position is the movement distance of the lower rail of the second electric window covering. Similarly, the upper limit position of the middle rail of the first electric window covering and the upper limit position of the middle rail of the second electric window covering are aligned at a second upper initial height position, and the distance between the current position of the middle rail of the first electric window covering and the second upper initial height position is the movement distance of the middle rail of the first electric window covering, and the distance between the current position of the middle rail of the second electric window covering and the second upper initial height position is the movement distance of the middle rail of the second electric window covering. Alternatively, the lower limit position of the lower rail of the first electric window covering and the lower limit position of the lower rail of the second electric window covering are aligned at a first lower initial height position, and the distance between the current position of the lower rail of the first electric window covering and the first lower initial height position is the movement distance of the lower rail of the first electric window covering, and the distance between the current position of the lower rail of the second electric window covering and the first lower initial height position is the movement distance of the lower rail of the second electric window covering. Similarly, the lower limit position of the middle rail of the first electric window covering and the lower limit position of the middle rail of the second electric window covering are aligned at a second lower initial height position, and the distance between the current position of the middle rail of the first electric window covering and the second lower initial height position is the movement distance of the middle rail of the first electric window covering, and the distance between the current position of the middle rail of the second electric window covering and the second lower initial height position is the movement distance of the middle rail of the second electric window covering.

In the above method, the lower rail of the first electric window covering and the lower rail of the second electric window covering are aligned at a lower rail alignment height position, and the middle rail of the first electric window covering and the middle rail of the second electric window covering are aligned at a middle rail alignment height position, with each of the lower rail alignment height position and the middle rail alignment height position being an integer multiple of the minimum scale.

In the above method, the first alignment packet further includes information about the maximum movement distance of the lower rail of the first electric window covering between the upper limit position and the lower limit position of the lower rail, a predetermined maximum alignment distance of the lower rail of the first electric window covering, the maximum movement distance of the middle rail of the first electric window covering between the upper limit position and the lower limit position of the middle rail, and a predetermined maximum alignment distance of the middle rail of the first electric window covering. The second alignment packet further includes information about the maximum movement distance of the lower rail of the second electric window covering between the upper limit position and the lower limit position of the lower rail, a predetermined maximum alignment distance of the lower rail of the second electric window covering, the maximum movement distance of the middle rail of the second electric window covering between the upper limit position and the lower limit position of the middle rail, and a predetermined maximum alignment distance of the middle rail of the second electric window covering.

In summary, the electric window covering, electric window covering system, and window covering alignment method provided by the present disclosure have at least the following features: (1)By applying the propagation packet automatic alignment method, each electric window covering can autonomously align itself without the need for an external centralized control console; (2) without the need for an external centralized control console, reducing costs and power consumption, making it more competitive in the market and aligning with energy-saving and carbon-reduction trends; (3) further enhancing alignment accuracy by incorporating the minimum scale alignment method; and (4) the window covering alignment method is applicable to various types of window coverings, such as the aforementioned honeycomb shades or blinds, and can also be used for roller shades, meaning that the electric window covering can be an electric honeycomb shade, an electric blind, or an electric roller shade. In simple terms, the window covering alignment method is versatile.

The present disclosure has been disclosed in the above embodiments, but it should be understood by those skilled in the art that the above embodiments are only used to describe the present disclosure and are not intended to limit the scope of the patent rights claimed by the present disclosure. Any changes or substitutions that are equivalent or similar to the above embodiments should be interpreted as falling within the spirit or scope of the present disclosure. Therefore, the scope of protection of the present disclosure should be determined by the scope of the following patent claims.

What is claimed is:

1. A first electric window covering, comprising:
an upper rail;
a lower rail disposed below the upper rail and driven to move relative to the upper rail between an upper limit position and a lower limit position of the lower rail;
a lower rail driving assembly comprising a lower rail motor and a lower rail encoder, wherein the lower rail encoder senses rotation of a lower rail motor to generate a lower rail encoding signal representing a current position of the lower rail;
a control device electrically connected to the lower rail motor and the lower rail encoder, the control device configured to control the lower rail motor to drive the lower rail to move and to receive the lower rail encoding signal from the lower rail encoder; and
a power supply unit electrically connected to the lower rail motor, the control device, and the lower rail encoder;
wherein the control device, upon receiving a specific remote control command, transmits a first alignment packet to a second electric window covering and receives a second alignment packet from the second electric window covering, and controls the lower rail motor to align the lower rail based on the first alignment packet and the second alignment packet, wherein the first alignment packet includes at least information about the current position of the lower rail of the first electric window covering when it is stopped or stationary, and the second alignment packet includes at least information about a current position of a lower rail of the second electric window covering when it is stopped or stationary.

2. The first electric window covering according to claim 1, further comprising:
a middle rail disposed between the upper rail and the lower rail and driven to move relative to the upper rail between an upper limit position and a lower limit position of the middle rail; and
a middle rail driving assembly comprising a middle rail motor and a middle rail encoder, wherein the middle rail encoder senses rotation of the middle rail motor to generate a middle rail encoding signal representing a current position of the middle rail;
wherein the power supply unit is electrically connected to the middle rail motor and the middle rail encoder;
wherein the control device is electrically connected to the middle rail encoder and the middle rail motor, and is configured to control the middle rail motor to drive the middle rail to move and to receive the middle rail encoding signal from the middle rail encoder, wherein the first alignment packet further includes information about the current position of the middle rail of the first electric window covering when it is stopped or stationary, and the second alignment packet further includes information about a current position of a middle rail of the second electric window covering when it is stopped or stationary;
wherein the control device, upon receiving the specific remote control command, controls the lower rail motor to align the lower rail and controls the middle rail motor to align the middle rail based on the first alignment packet and the second alignment packet.

3. The first electric window covering according to claim 1, wherein the upper limit position of the lower rail of the first electric window covering and an upper limit position of the lower rail of the second electric window covering are aligned at a first upper initial height position, and a distance between the current position of the lower rail and the first upper initial height position is a movement distance of the lower rail; or wherein the lower limit position of the lower rail of the first electric window covering and a lower limit position of the lower rail of the second electric window covering are aligned at a first lower initial height position, and a distance between the current position of the lower rail and the first lower initial height position is the movement distance of the lower rail.

4. The first electric window covering according to claim 2, wherein the upper limit position of the lower rail of the first electric window covering and an upper limit position of the lower rail of the second electric window covering are aligned at a first upper initial height position, and a distance between the current position of the lower rail and the first upper initial height position is a movement distance of the lower rail, and wherein the upper limit position of the middle rail of the first electric window covering and an upper limit position of the middle rail of the second electric window covering are aligned at a second upper initial height position, and a distance between the current position of the middle rail and the second upper initial height position is a movement distance of the middle rail; or wherein the lower limit position of the lower rail of the first electric window covering and a lower limit position of the lower rail of the second electric window covering are aligned at a first lower initial height position, and a distance between the current position of the lower rail and the first lower initial height position is the movement distance of the lower rail, and wherein the lower limit position of the middle rail of the first electric window covering and a lower limit position of the middle rail of the second electric window covering are aligned at a second lower initial height position, and a distance between the current position of the middle rail and the second lower initial height position is the movement distance of the middle rail.

5. The first electric window covering according to claim 3, wherein after the control device controls the lower rail motor to align the lower rail based on the first alignment packet and the second alignment packet, the lower rail is at a lower rail alignment height position, and the lower rail alignment height position is an integer multiple of a minimum scale.

6. The first electric window covering according to claim 4, wherein after the control device controls the lower rail motor to align the lower rail and controls the middle rail motor to align the middle rail based on the first alignment packet and the second alignment packet, the lower rail is at a lower rail alignment height position, the middle rail is at a middle rail alignment height position, and each of the lower rail alignment height position and the middle rail alignment height position is an integer multiple of a minimum scale.

7. The first electric window covering according to claim 1, wherein the first alignment packet further includes information about a maximum movement distance of the lower rail of the first electric window covering between the upper limit position and the lower limit position of the lower rail and a predetermined maximum alignment distance of the lower rail, and wherein the second alignment packet further includes information about a maximum movement distance of the lower rail of the second electric window covering between an upper limit position and a lower limit position of the lower rail and a predetermined maximum alignment distance of the lower rail.

8. The first electric window covering according to claim 2, wherein the first alignment packet further includes information about a maximum movement distance of the lower rail of the first electric window covering between the upper limit position and the lower limit position of the lower rail, a predetermined maximum alignment distance of the lower rail, a maximum movement distance of the middle rail of the first electric window covering between the upper limit position and the lower limit position of the middle rail, and a predetermined maximum alignment distance of the middle rail, and wherein the second alignment packet further includes information about a maximum movement distance of the lower rail of the second electric window covering between an upper limit position and a lower limit position of the lower rail, a predetermined maximum alignment distance of the lower rail, a maximum movement distance of the middle rail of the second electric window covering between an upper limit position and a lower limit position of the middle rail, and a predetermined maximum alignment distance of the middle rail.

9. The first electric window covering according to claim 1, wherein the control device controls the lower rail motor to align the lower rail based on the first alignment packet, the second alignment packet, and a previous movement direction of the lower rail.

10. A window covering alignment method for a first electric window covering and a second electric window covering, comprising:
after a control device of the first electric window covering receives a specific remote control command, the first electric window covering transmits a first alignment packet to the second electric window covering, wherein the first alignment packet includes information about a current position of a lower rail of the first electric window covering when it is stopped or stationary;
after a control device of the second electric window covering receives the specific remote control command, the second electric window covering transmits a second alignment packet to the first electric window covering, wherein the second alignment packet includes information about a current position of a lower rail of the second electric window covering when it is stopped or stationary;
the control device of the first electric window covering controls a lower rail motor of the first electric window covering to align the lower rail of the first electric window covering based on the first alignment packet and the second alignment packet; and
the control device of the second electric window covering controls a lower rail motor of the second electric window covering to align the lower rail of the second electric window covering based on the first alignment packet and the second alignment packet.

11. The window covering alignment method according to claim 10, wherein the first alignment packet further includes information about a current position of a middle rail of the first electric window covering when it is stopped or stationary, and the second alignment packet further includes information about a current position of a middle rail of the second electric window covering when it is stopped or stationary, and wherein the control device of the first electric window covering and the control device of the second electric window covering independently control their respective lower rail motors to align their lower rails based on the first alignment packet and the second alignment packet, and independently control their respective middle rail motors to align their middle rails based on the first alignment packet and the second alignment packet.

12. The window covering alignment method according to claim 10, wherein an upper limit position of the lower rail of the first electric window covering and an upper limit position of the lower rail of the second electric window covering are aligned at a first upper initial height position, and a distance between the current position of the lower rail of the first electric window covering and the first upper initial height position is a movement distance of the lower rail of the first electric window covering, and a distance between the current position of the lower rail of the second electric window covering and the first upper initial height position is a movement distance of the lower rail of the second electric window covering; or wherein a lower limit position of the lower rail of the first electric window covering and a lower limit position of the lower rail of the second electric window covering are aligned at a first lower initial height position, and a distance between the current position of the lower rail of the first electric window covering and the first lower initial height position is the movement distance of the lower rail of the first electric window covering, and a distance between the current position of the lower rail of the second electric window covering and the first lower initial height position is the movement distance of the lower rail of the second electric window covering.

13. The window covering alignment method according to claim 11, wherein an upper limit position of the lower rail of the first electric window covering and an upper limit position of the lower rail of the second electric window covering are aligned at a first upper initial height position, and a distance between the current position of the lower rail of the first electric window covering and the first upper initial height position is a movement distance of the lower rail of the first electric window covering, and a distance between the current position of the lower rail of the second electric window covering and the first upper initial height position is a movement distance of the lower rail of the second electric window covering, and wherein an upper limit position of the middle rail of the first electric window covering and an upper limit position of the middle rail of the second electric window covering are aligned at a second upper initial height position, and a distance between the current position of the middle rail of the first electric window covering and the second upper initial height position is a movement distance of the middle rail of the first electric window covering, and a distance between the current position of the middle rail of the second electric window covering and the second upper initial height position is a movement distance of the middle rail of the second electric window covering; or wherein a lower limit position of the lower rail of the first electric window covering and a lower limit position of the lower rail of the second electric window covering are aligned at a first lower initial height position, and a distance between the current position of the lower rail of the first electric window covering and the first lower initial height position is the movement distance of the lower rail of the first electric window covering, and a distance between the current position of the lower rail of the second electric window covering and the first lower initial height position is the movement distance of the lower rail of the second electric window covering, and wherein a lower limit position of the middle rail of the first electric window covering and a lower limit position of the middle rail of the second electric window covering are aligned at a second lower initial height position, and a distance between the current position of the middle rail of the first electric window covering and the second lower initial height position is the movement distance of the middle rail of the first electric window covering, and a distance between the current position of the middle rail of the second electric window covering and the second lower initial height position is the movement distance of the middle rail of the second electric window covering.

14. The window covering alignment method according to claim 11, wherein the lower rail of the first electric window covering and the lower rail of the second electric window covering are aligned at a lower rail alignment height position, and the middle rail of the first electric window covering and the middle rail of the second electric window covering are aligned at a middle rail alignment height position, and each of the lower rail alignment height position and the middle rail alignment height position is an integer multiple of a minimum scale.

15. The window covering alignment method according to claim 13, wherein the first alignment packet further includes information about a maximum movement distance of the lower rail of the first electric window covering between the upper limit position and the lower limit position of the lower rail, a predetermined maximum alignment distance of the lower rail of the first electric window covering, a maximum movement distance of the middle rail of the first electric window covering between the upper limit position and the lower limit position of the middle rail, and a predetermined maximum alignment distance of the middle rail of the first electric window covering, and wherein the second alignment packet further includes information about a maximum movement distance of the lower rail of the second electric window covering between the upper limit position and the lower limit position of the lower rail, a predetermined maximum alignment distance of the lower rail of the second electric window covering, a maximum movement distance of the middle rail of the second electric window covering between the upper limit position and the lower limit position of the middle rail, and a predetermined maximum alignment distance of the middle rail of the second electric window covering.

16. An electric window covering system, comprising:
the first electric window covering according to claim 1; and
the second electric window covering, wirelessly connected to the first electric window covering.
